(19) United States
(12) Patent Application Publication
(10) Pub. No.: US 2007/0297730 A1
(43) Pub. Date: Dec. 27, 2007

(54) Optical fiber assemblies having one or more water-swellable members

(76) Inventors: Anne G. Bringuier, Taylorsville, NC (US); George C. Abernathy, Hildebran, NC (US); William C. Hurley, Hickory, NC (US); David A. Seddon, Hickory, NC (US); W. Welch McCollough, Newton, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/471,933

(22) Filed: Jun. 21, 2006

(51) Int. Cl. G02B 6/44

(52) U.S. Cl. 385/113; 385/100; 385/109

(57) ABSTRACT

Disclosed are fiber optic assemblies having at least one optical fiber and at least one water-swellable yarn disposed within a tube that preserves optical performance. Optical performance is preserved by selecting water-swellable yarns for the fiber optic assemblies that are softer and loftier since at least some of the filaments have a textured characteristic. In one embodiment, the water-swellable yarn has a stretch ratio of about 2 or more, where the stretch ratio is defined as the nominal unstretched diameter divided by the nominal stretched diameter. In another embodiment, the water-swellable yarn has a textured elongation factor of about 2% or more. Additionally, embodiments may position the optical fibers radially outward of the water swellable yarn(s), thereby further preserving optical performance.

### FIELD OF THE INVENTION

The present invention relates generally to optical fiber assemblies used for transmitting optical signals. More particularly, the present invention relates to optical fiber assemblies having one or more water-swellable members.

### BACKGROUND OF THE INVENTION

Communications networks are used to transport a variety of signals such as voice, video, data and the like. As communications applications required greater bandwidth, communication networks switched to cables having optical fibers since they are capable of transmitting an extremely large amount of bandwidth compared with a copper conductor. Moreover, a fiber optic cable is much smaller and lighter compared with a copper cable having the same bandwidth capacity. However, optical fibers are relatively sensitive compared with copper conductors and persevering their optical performance in certain applications can be challenging.

Some fiber optic cable applications require the cables to block the migration of water within the cable. Conventional fiber optic cables block water migration using a filling material such as gel or grease within the cable. The filling material has many advantages besides water blocking, such as cushioning and coupling the optical fibers which assists maintaining optical performance during mechanical or environmental events affecting the cable, but filling materials also have disadvantages. One disadvantage is that the filling material must be cleaned from the optical fibers when being prepared for an optical connection, which adds time and complexity for the craft. Consequently, alternate methods of water blocking were developed for eliminating the filling material from fiber optic cables.

For instance, some fiber optic cable designs incorporated super-absorbent polymers (SAPs) for water-blocking. SAPs function by absorbing water and swelling as a result, thereby blocking the water path and inhibiting the migration of water along the cable. Some of the early designs used SAPs in a powder form within the fiber optic cable. Using SAPs as a powder within the fiber optic cable created problems since the SAPs powders could accumulate at positions within the cable (i.e., SAPs powders would accumulate at the low points when wound on a reel due to gravity), thereby causing inconsistent water blocking within the fiber optic cable. To overcome this accumulation problem, SAPs or superabsorbent filaments were used with a yarn or tape as a carrier.

For instance, one type of conventional water-swellable yarn uses water-swellable particles disposed on a yarn having filaments that are relatively tightly twisted and/or held together. This type of conventional water-swellable yarn has sufficient water-blocking capabilities and inhibits the accumulation as with SAPs applied as a powder, but is relatively hard, bulky, has a rough surface, and is large compared with a typical optical fiber. Another type of conventional water-swellable yarn is made using superabsorbent fibers spun with polyester filaments. The superabsorbent fibers and the polyester filaments are spun relatively tightly together to hold the fibers and filaments together, again forming a yarn that is relatively hard and bulky with a rough surface and is relatively large in comparison with a typical optical fiber. These conventional water-swellable yarns can cause problems if the optical fiber is pressed against the same. Stated another way, optical fibers pressed against the conventional water-swellable yarn may experience microbending which can cause undesirable levels of optical attenuation. Consequently, water-swellable yarns were first commercially used within cable where they could not contact the optical fibers. However, interest developed in using the water-swellable yarns where contact with optical fibers could occur.

One example of conventional water swellable components used within a buffer tube where contact with the optical fiber is possible is disclosed in U.S. Pat. No. 4,909,592. But, including conventional water-swellable components within the buffer tube can still cause issues with cable performance that required limitations on use and/or other design alterations. For instance, cables using conventional water-swellable yarns within the buffer tube required larger buffer tubes to minimize the interaction of conventional water swellable yarns and optical fibers and/or limited the environment where the cable is used. The present invention is directed to fiber optic assemblies that use water-swellable yarns while still preserving optical performance.

### SUMMARY OF THE INVENTION

The present invention is directed to fiber optic assemblies that preserve optical performance. One aspect of the present invention is directed to a fiber optic assembly including at least one optical fiber and at least one water-swellable yarn. The at least one water-swellable yarn has a plurality of filaments with a textured characteristic. Additionally, the at least one water-swellable yarn has a nominal unstretched diameter and a nominal stretched diameter when a suitable tension is applied that essentially removes the textured characteristic from the plurality of filaments having the textured characteristic. A stretch ratio is defined as the nominal unstretched diameter divided by the nominal stretched diameter and the stretch ratio has a value of about 2 or more.

Another aspect of the present invention is directed to a fiber optic assembly having at least one optical fiber and at least one water-swellable yarn. The at least one water-swellable yarn has a plurality of filaments with a textured characteristic and the at least one water-swellable yarn has a textured elongation factor of about 2% or more.

Still another aspect of the present invention is directed to a fiber optic assembly including at least one water-swellable yarn and at least one optical fiber disposed within a tube. The plurality of optical fibers are disposed radially outward of the at least one water-swellable yarn for allowing the plurality of optical fibers to move radially outward toward the interior surface of the tube, thereby preserving optical performance. Additionally, the fiber optic assembly can have at least one water-swellable yarn with a plurality of filaments having a textured characteristic.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principals and operations of the invention.

### BRIEF DESCRIPTION OF THE DRAWINGS

FIG. 1 is a cross-sectional view of a fiber optic assembly according to the present invention.

FIG. 2a shows a cross-sectional view and a top view of an unstretched water-swellable yarn such as used in the fiber optic assembly of FIG. 1.

FIG. 2b shows a cross-sectional view and a top view of the water-swellable yarn of FIG. 2a after being stretched.

FIG. 3 is a graph depicting the tensile force required for elongating of a conventional water-swellable yarn and a textured water-swellable yarn according to the concepts of the present invention.

FIG. 4 is a graph depicting three explanatory curves for three different water-swellable yarns according to the concepts of the present invention.

FIG. 5 is a cross-sectional view of another fiber optic assembly according to the present invention.

FIGS. 6a and 6b are cross-sectional views of fiber optic assemblies that are configured as cables according to the present invention.

FIG. 7 is a cross-sectional view of another fiber optic assembly configured in a cable according to the present invention.

FIG. 8 is the cross-sectional view of still another fiber optic assembly configured in a cable according to the present invention.

FIGS. 9 and 10 are cross-sectional views of other fiber optic assemblies configured as a cable according to the present invention.

### DETAILED DESCRIPTION OF THE INVENTION

The present invention is directed to fiber optic assemblies comprising optical fibers and water-swellable yarns disposed within a tube, a cavity, a cable, or the like. Moreover, one or more of the fiber optic assemblies may be used in a cable or may itself form a cable. The present invention preserves the optical performance of the optical fibers during, and after, exposure to harsh field handling, and/or temperature variations as revealed by mechanical and thermal testing. More specifically, the present invention has several advantages compared with conventional fiber optic assemblies using conventional water-swellable yarns. For instance, one benefit is that fiber optic assemblies of the present invention may have improved low temperature performance, thereby allowing use of the fiber optic assemblies of the invention in a wider range of environments. Another advantage of the present invention is a significant reduction in optical attenuation measured for fiber optic assemblies during crush testing.

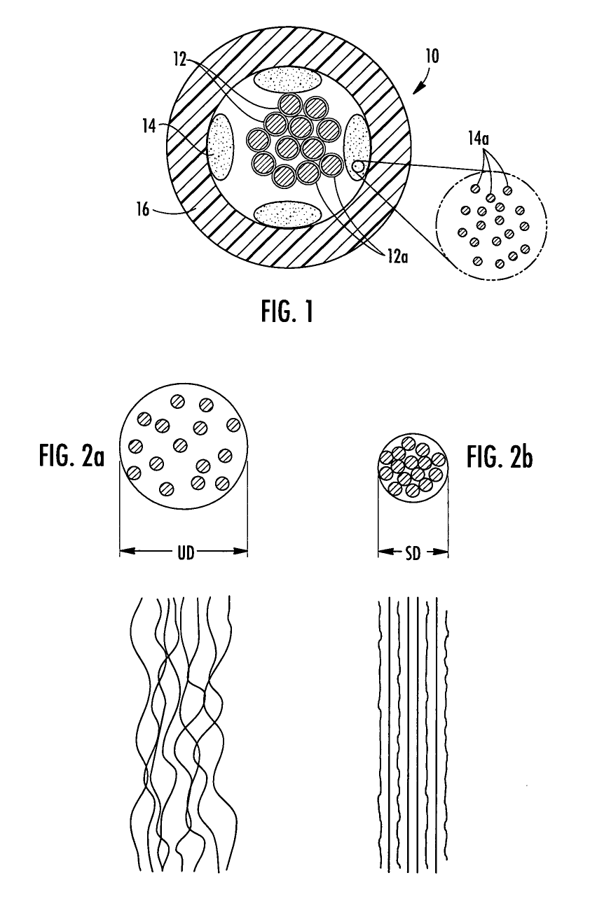

Reference will now be made in detail to the present preferred embodiments of the invention, examples of which are illustrated in the accompanying drawings. Whenever possible, the same reference numerals will be used throughout the drawings to refer to the same or like parts. FIG. 1 depicts a cross-sectional view of a fiber optic assembly 10 according to the present invention. Fiber optic assembly 10 includes a plurality of optical fibers 12, a plurality of water-swellable yarns 14, and a tube 16. Optical fibers 12 may be any suitable type of optical waveguide as known or later developed. In this embodiment, optical fibers 12 are colored by an outer layer 12a of ink for identification 12 and are loosely disposed within tube 16. In other words, optical fibers 12 are non-buffered, but the concepts of the present invention may be used with optical fibers having other configurations such as buffered, ribbonized, etc. Water-swellable yarns 14 provide water-blocking within tube 16 and are disposed radially outward of optical fibers 12. As shown by the detail bubble of FIG. 1, water-swellable yarn 14 includes a plurality of filaments 14a that are loosely grouped together instead of being twisted tightly together. In this embodiment, water-swellable yarn 14 has a denier between about 100 and about 1000, but any suitable denier may be used.

Unlike conventional water-swellable yarns, water-swellable yarns of the present invention have one or more characteristics that preserve the optical performance of optical fibers within fiber optic assemblies. By way of example, one or more of filaments 14a of water-swellable yarn 14 have a textured characteristic, thereby imparting a relatively soft and/or lofty structure to the same. As used herein, a textured characteristic means one or more of the filaments of the water-swellable yarn has an actual length that is longer than the axial length of the relevant portion of the water-swellable yarn. Illustratively, one or more filaments have a length that is about 2% or more than the actual length of the water-swellable yarn. Generally speaking, the water-swellable yarns tend to conform (such as flatten out) when compressed or contacted since the filaments are not twisted or spun together, but water-swellable yarns may include a degree of entanglement, twisting, or the like for keeping the filaments in a group. Consequently, fiber optic assemblies of the present invention can withstand larger contact forces between optical fibers and water-swellable yarns before causing undesirable levels of optical attenuation.

Simply stated, filaments 14a of water-swellable yarn 14 are wavy (i.e., have a curvy path) along the longitudinal length of the water-swellable yarn. Filaments having a textured characteristic may be made formed using any suitable process. One typical method of applying a textured characteristic to the water-swellable yarn is to treat it with hot air jets, such that the individual filaments become wavy and, in an unstressed state, will not be straight (i.e., the filaments are longer than the length water-swellable yarn). Moreover, the textured characteristic may have different types of shape distortions. For instance, the shape distortion for the majority of the filaments may be somewhat regular or the shape distortion among the filaments may be somewhat irregular. Nonetheless, fiber optic assemblies using water-swellable yarns having a textured characteristic provide improved performance compared with conventional fiber optic assemblies. Moreover, water-swellable yarns have between about 100 and 1000 filaments per thousand denier and each filament has a diameter of about 50 microns or less, but water-swellable yarns/filaments may have other suitable values. Illustratively, a 500 denier yarn has between about 50 and 500 filaments. Suitable water-swellable yarns are available from Fil-Tec of Hagerstown, Md.

Fiber optic assemblies of the present invention can use one or more water-swellable yarns having different levels of the textured characteristic. FIGS. 2a and 2b depict one method of quantifying the amount of textured characteristic in water-swellable yarn. FIG. 2a depicts a cross-sectional view and a top view of water-swellable yarn 14 in a relaxed state (i.e., no tension is applied to the same). As shown in the cross-sectional view of FIG. 2a, water-swellable yarn 14 has a nominal unstretched diameter UD. When a tensile force is applied to water-swellable yarn 14, the length of water-swellable yarn increases (e.g., the water-swellable yarn elongates) and the textured characteristic decreases along with a nominal stretched diameter SD as shown in FIG. 2b. In other words, the tensile force straightens out filaments 14a as they pull toward the middle. Generally speaking, when the tension is released the water-swellable yarn returns to its initial unstretched length.

Consequently, a stretch ratio of the nominal unstretched diameter UD to nominal stretched diameter SD can be defined and calculated. By way of example, a 300 denier water-swellable yarn according to the present invention was determined to have the nominal unstretched diameter UD of about 2.866 millimeters while its nominal stretched diameter SD was about 0.669 millimeters with an applied tension of about 0.05 grams per denier. The denier of the water-swellable yarn was determined before the application of the SAP and its binder, the addition of which increases the weight of the same to about 500 denier. Thus, the water-swellable yarn had a stretch ratio of about 4.5 to 1 (i.e., 2.866 to 0.669) for the applied tension of about 15 grams (i.e., 300 denier times about 0.05 grams per denier). For the test, measuring of the unstretched and stretched water-swellable yarns was accomplished by holding the same above a ruler and taking a picture. Thereafter, the image was imported into a computer drawing package for determining the respective nominal diameters of the same. Fiber optic assemblies of the present invention have a stretch ratio of about 2 to 1 or more; however, the value of tension applied for determining the stretch ratio can vary depending on the filaments of the water-swellable yarn. For instance, if the water-swellable yarn has one or more filaments acting as a strength member (i.e., the filaments do not have a textured characteristic) more tension may be required to strain the strength member filaments before removing the majority of the textured characteristic from the filaments having the textured characteristic.

Another useful way for determining the level of the textured characteristic is by measuring a textured elongation factor. As used herein, the textured elongation factor is defined as the percent increase in length of the water-swellable yarn before the filaments become substantially parallel and the filaments are elongated (i.e., strained) rather than just straightened when a suitable tension is applied. An Instron or other suitable device may be used to measure the textured elongation factor. Measurement of the textured elongation factor is relatively straight-forward since the tensile force/stress necessary to straighten the filaments of the water-swellable yarn having the textured characteristic is relatively low. After the filaments are straightened, there is a significant increase in the tensile force/stress required to continue elongating the water-swellable yarn because the filaments are being strained. The value where there is a significant increase in the tensile force required for elongation is defined as the textured elongation factor.

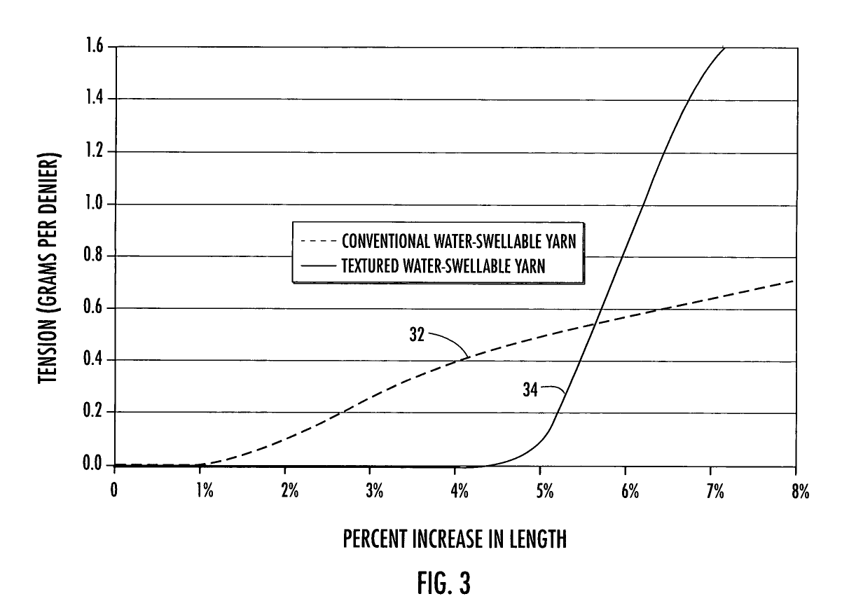

FIG. 3 depicts an explanatory graph depicting the tensile force required for elongating a conventional water-swellable yarn and water-swellable yarn 14 to determine the textured elongation factor. As depicted, the scale for the tension is normalized as grams per denier. Curve 32 represents a 450 denier water-swellable yarn where the filaments are twisted together available from Tilsatec of West Yorkshire, England. As shown by curve 32, after about 1% length increase the tension required for further length increase rises because the filaments of the same are being strained. Consequently, the conventional water-swellable yarn has a textured elongation factor of about 1%. On the other hand, curve 34 depicts water-swellable yarn 14 with a denier of 300 (the addition of SAP and binder increases the denier to about 500). As shown by curve 34, after about a 4% length increase, the tension required for increasing the length further increases dramatically because the textured characteristic is essentially removed and the filaments are being strained. Thus, the water-swellable yarn 14 represented by curve 34 has a textured elongation factor of about 4%. Simply stated, the textured elongation factor is the value where essentially all of the textured characteristic is pulled from the water-swellable yarn so that essentially all of the filaments must be strained for elongation, thereby requiring a significant increase in tension for further elongation.

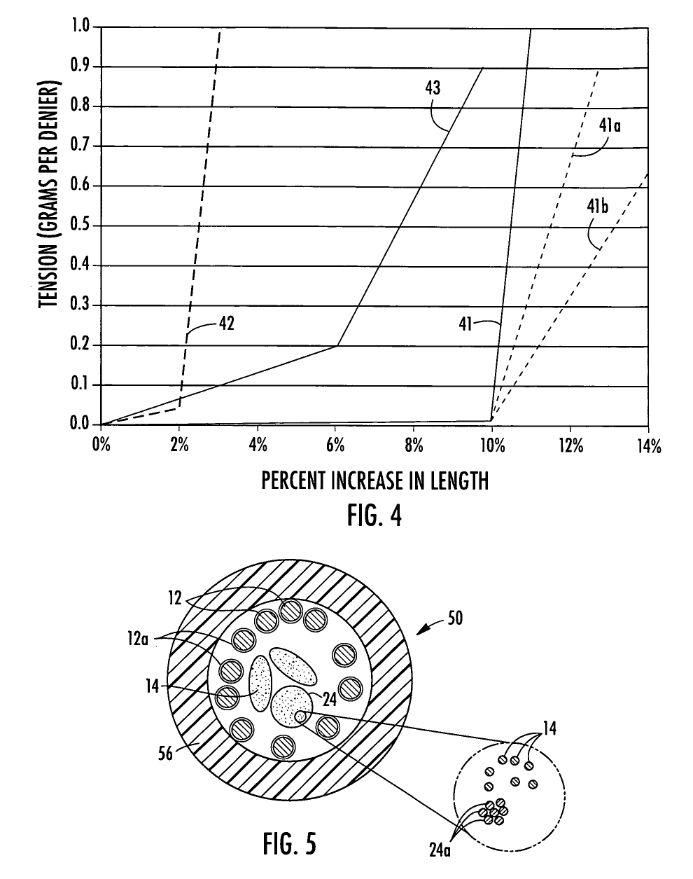

The textured elongation factor for fiber optic assemblies of the present invention is preferably about 2% or more, and more preferably in the range of about 3% to about 15% when a suitable tensile force is applied. For instance, if all of the filaments of the water-swellable yarn include the textured characteristic a tension of about 0.05 grams per denier is generally suitable for essentially removing the textured characteristic to determine the textured elongation factor and/or stretch ratio, but other suitable tensions may be necessary for measuring the textured characteristics. FIG. 4 depicts three explanatory curves 41, 42, and 43 that represent water-swellable yarns for use in fiber optic assemblies according to the present invention. More specifically, curves 41 and 42 respectively represent water-swellable yarns with textured elongation factors of about 10% and about 2%. Whereas, curve 43 represents a composite water-swellable yarn having both filaments with the textured characteristic and filaments that essentially lack a textured characteristic (i.e., filaments that act as strength members), thereby requiring more force for determining the textured elongation factor. Composite yarns may be advantageous since they allow the tailoring of desired characteristics and can aid processing during manufacturing.

Generally speaking, the filaments of water-swellable yarn represented by curve 41 are generally being straightened below the 10% value for the textured elongation factor of 10%, which requires only a relatively small force (i.e., a relatively small slope for the initial portion of the curve). Above 10% essentially all of the filaments of the water-swellable yarn represented by curve 41 are being strained, thereby requiring a relatively large increase in the force (i.e., a relatively large slope for the remainder of the curve represented by the solid line) required for further elongation as shown. Furthermore, other water-swellable yarns can have other slopes for the initial and/or remainder of the curve depending on its characteristics. By way of example, curve 41 has two representative phantom lines for the second portion of curve 41. Phantom lines 41a and 41b represent the use of different filament materials in the water-swellable yarn. By way of example, the original curve 41 has the steepest slope and represents filaments having a relatively high-strength such as aramid filaments; phantom line 41a has a smaller slope and represents filaments having a medium-strength such as polyester filaments; and phantom line 41b represents filaments having a relatively low-strength such as acrylic filaments. Curve 42 represents another water-swellable yarn with about a 2% textured elongation factor. Curve 42 has a steeper initial slope compared with curve 41 indicating that some filaments are most likely being strained while the majority of filaments are just being straightened. Stated another way, the majority of the filaments are being straightened up to about 2% and above 2% the majority of filaments are being strained. Thus, the textured elongation factor of water-swellable yarn represented by curve 42 is about 2%.

Curve 43 represents a third water-swellable yarn including one or more filaments acting like strength members (i.e., the strength member filament has a relatively small textured elongation factor before being strained) with about a 6% textured elongation factor. Including one or more filaments that acts like strength members in the water-swellable yarn allows some back tension when paying off of the water-swellable yarn during manufacturing. In other words, the strength element filaments inhibit the other filaments in the water-swellable yarn from losing their textured characteristic from the back tension. As depicted, curve 43 has the steepest initial slope indicating that some filaments are most likely being strained while some of the filaments are being straightened up to about 6%. Above about 6% essentially all of the filaments of the water-swellable yarn represented by curve 43 are being strained. Moreover, curve 43 depicts that it requires about 0.2 grams per denier for essentially removing the textured characteristic from the water-swellable yarn. Water-swellable yarns with one or more different types of filaments such as composite water-swellable yarns having filaments that act as strength members can be manufactured using different methods. One method is to make the water-swellable yarn as a roving. In other words, one or more yarns having a textured characteristic are combined with one or more yarns that do not have a textured characteristic. Illustratively, a 300 denier water-swellable yarn with a textured characteristic can be combined with a 100 denier aramid yarn that provides tensile strength. In this example, a ratio of textured characteristic filaments to strength member filaments is 3 to 1 (e.g., 300 denier to 100 denier), but other ratios are possible such as 1 to 1, 5 to 1, or other suitable values. Curves 41, 42, and 43 are explanatory and water-swellable yarns can have other suitable curves for the textured elongation factor.

The water-swellable characteristic of water-swellable yarn 14 can be provided by attaching super absorbent polymers (SAPs) to filaments 14a and/or applying a coating to filaments 14a that is water-swellable. One factor that can affect optical performance is the maximum particle size of the SAPs and/or the surface texture of the coating. A smooth coating and/or relatively small maximum particle size, when combined with a suitable diameter for the filaments, inhibits microbending if the optical fibers should contact the water-swellable yarn. The maximum SAP particle size is preferably about 100 microns or less, but other suitable maximum particles sizes are possible. Using SAPs with a somewhat larger maximum particle size may still provide acceptable performance, but using a larger maximum particle size increases the likelihood of experiencing increased optical attenuation. Thus, the water-swellable yarns can spread out (i.e., deform) when the optical fibers are pushed against them such as during crush or when exposed to cold temperatures that cause optical performance issues.

FIG. 5 depicts a fiber optic assembly 50 according to the present invention. Fiber optic assembly 50 includes a plurality of optical fibers 12, a plurality of first water-swellable yarns 14, a second water-swellable yarn 24, and a tube 56. In this embodiment, second water-swellable yarn 24 includes two different types of filaments and optical fibers 12 include an outer layer 12a having a lubricant. More specifically, second water-swellable yarn 24 includes a plurality of filaments 24a that act as strength members and a plurality of filaments 14a that have a textured characteristic. This embodiment also has the first water-swellable yarns 14 and the second water-swellable yarn 24 disposed in the middle of the cable and stranded together. In other words, optical fibers 12 are disposed radially outward of water-swellable yarns 14,24, thereby improving low-temperature performance by advantageously allowing the optical fibers space to move radially outward toward the inner surface of the tube.

More specifically, low-temperature excursions can cause the optical fibers to move radially outward within the assembly since most polymers used for tubes, jackets, etc. shrink considerably more than the optical fibers at relatively low temperatures. If there are water-swellable yarns radially outward of the optical fibers as depicted in FIG. 1, one or more of the optical fibers may press against the water-swellable yarns during the low-temperature excursion, which may cause elevated levels of optical attenuation. It was discovered that low-temperature performance may be improved by positioning the optical fibers radially outward of the water-swellable yarns as depicted in FIG. 5. Positioning the optical fibers radially outward of the water-swellable yarns means that the optical fibers are inhibited from pressing the water-swellable yarn against the inner wall of the tube, cavity, or the like. Of course, there are other factors that may affect low temperature performance such as the inner diameter of the tube or cavity, number of optical fibers within the tube or cavity, friction between the optical fibers and other components, or the like.

For instance, fiber optic assembly 50 reduces the friction and/or inhibits sticking between optical fibers 12 and tube 56. Tubes extruded about optical fibers in fiber optic assemblies that exclude a separation layer (e.g., a grease, gel, or yarn,) disposed about the optical fibers can have issues with the optical fibers contacting and sticking to the tube while it is molten. Sticking to the inside of the tube causes the path of the optical fibers to be distorted, which may induce undesirable levels of optical attenuation. Embodiments of the present invention may use a lubricant in or on the outer layer of the optical fibers, thereby reducing the risk of optical fibers sticking to the extruded tube. Optical fibers 12 include an outer layer such as an ink having a suitable lubricant for inhibiting optical fibers 12 from sticking to tube 56 during extrusion of the same. Suitable lubricants include silicone oil, talc, or the like disposed in or on the outer layer. Other methods are also available for inhibiting the sticking of optical fibers with the tube. For instance, tube 56 may include one or more suitable fillers in the polymer, thereby inhibiting the adherence of the optical fibers with the tube. As an example, the tube may be constructed from a highly-filled PVC to inhibit sticking of the optical fibers. Furthermore, the tube may have a dual-layer construction with the inner layer of the tube having one or more suitable fillers in the polymer for inhibiting adhesion. Another way for inhibiting sticking of the optical fibers is to apply a lubricant to the inner wall of the tube or cavity shortly after forming the same.

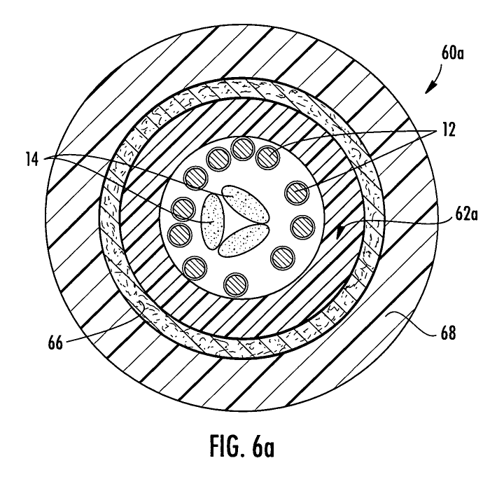

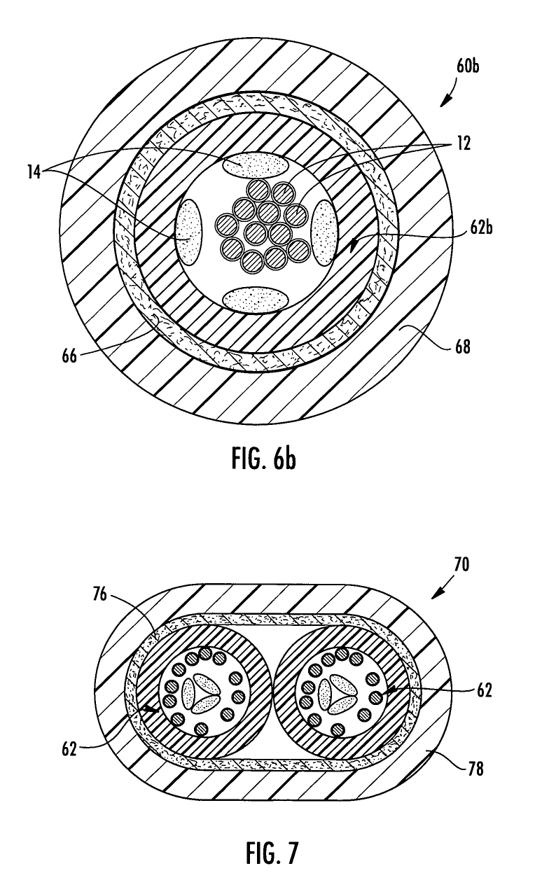

FIGS. 6a and 6b respectively depict a fiber optic cable 60a and a fiber optic cable 60b that are configured as single tube fiber optic cables according to the present invention. Fiber optic cables 60a and 60b are similar, except for assemblies 62a and 62b. Assembly 62a has four water-swellable yarns 14 that are disposed radially outward of optical fibers 12 and assembly 62b has optical fibers 12 disposed radially outward of three water-swellable yarns 14. Fiber optic cables 60a and 60b both include a plurality of strength elements 66 and a cable jacket 68. Strength elements 66 provide tensile strength to fiber optic cable 60 to handle the application tensile forces to fiber optic cable 60 such as during the installation of the same. Strength elements 66 may be any suitable material such as aramid, fiberglass, or the like and in this embodiment strength elements 66 are a water-swellable fiberglass for inhibiting the migration of water outward of the tube. In other embodiments, the strength elements may have a rod-like structure. By way of example, one or more glass-reinforced plastic (GRPs) may be positioned adjacent the tube and then have cable jacket 68 applied thereover. In one embodiment, one or more pair GRPs, steel wires, or the like can be disposed adjacent to the tube about 180 degrees apart, thereby imparting a preferential bend characteristic to the fiber optic cable.

Cable jackets 68 of fiber optic cables 60a and 60b may use any suitable material such as a polymer for providing environmental protection. In one embodiment, cable jacket 68 is formed from a flame-retardant material, thereby making the fiber optic cable flame retardant. Likewise, the tube (not numbered) of assemblies 62a and 62b may also be formed from a flame-retardant material, but using a flame-retardant for the tube may not be necessary for making a flame-retardant cable. In these embodiments, cable jacket 68 is formed from a polyvinylidene fluoride (PVDF) and the tube is formed from a polyvinyl chloride (PVC). Of course, the use of other flame retardant materials is possible such as flame-retardant polyethylene or flame-retardant polypropylene.

Table 1 is a comparison of low-temperature optical attenuations for the fiber optic cables 60a and 60b during testing according to ICEA-696 showing a typical magnitude of attenuation improvement. More specifically, Table 1 compares the optical attenuations for the fiber optic cables at −40° C. with the additional measurements at −30° C. As discussed above, fiber optic cables 60a and 60b are similar, except that assemblies 62a and 62b are different as discussed above. Additionally, the tubes of assemblies 62a and 62b each had a nominal inner diameter of 1.9 millimeters and each included twelve single-mode optical fibers 12 with outer ink layer 12a having a silicone based lubricant. Both tubes were formed from a PVC available from Gulf-Western under the tradename GW 8670-B. Both tubes also used the same type of water-swellable yarns. The filaments of the water-swellable yarns were heated with air jets to create a textured characteristic with the textured elongation factor being about 4%. The temperature cycling test for this experiment was performed using an OTDR measurement with the fiber optic cables on respective reels in a temperature chamber. As depicted by Table 1, placement of the optical fibers radially outward of the water-swellable yarns in assembly 60a resulted in a significantly reduced optical attenuation at −30° C. and at −40° C.

TABLE 1
Comparison of low-temperature performance

| | Optical Attenuation | Optical Attenuation |
|---|---|---|
| Cable Type | at −30° C. | at −40° C. |
| | 0.15 dB/km | 0.16 dB/km |
| | 4.79 dB/km | 15.40 dB/km |

Fiber optic assemblies of the present invention also show a significant improvement in crush performance compared with a conventional assembly having a similar structure. In order to determine the effects of the present invention, crush testing was performed on tube assemblies instead of on fiber optic cables as is typical. In other words, crush testing was performed on round tube assemblies, which excluded a sheathing system (i.e., no strength elements or cable jacket to dissipate the crush forces). The crush test was performed by placing the round assemblies on a 10 centimeter long flat plate and applying a predetermined load on a parallel flat plate also 10 centimeters long on the top of the assembly being tested according to the procedure in TIA/EIA-455-41A (which is referred to as FOTP-41) while measuring the delta attenuation. Table 2 shows the maximum delta attenuation experienced during crush testing for conventional assemblies and assemblies of the present invention at two different predetermined crush forces. Each assembly that was crush tested included twelve optical fibers and had the same nominal tube dimensions. Moreover, conventional assemblies were made and tested with single-mode optical fibers (SMF) and multi-mode optical fibers (MMF). The conventional assemblies tested were similar to fiber optic assembly 10, but used four 450 denier conventional twisted water-swellable yarns commercially available from Tilsatec radially outward of the optical fibers. Likewise, assemblies of the present invention were made and tested with SMF and MMF as shown in Table 2. The assemblies of the present invention that were tested were similar to assembly 62a. An optical power through delta attenuation measurement was made at a reference wavelength of 1550 nanometers for the SMF and at 1300 nanometers for the MMF. As depicted by Table 2, the assemblies of the present invention resulted in a significant reduction of delta attenuation over the conventional assemblies.

TABLE 2
Comparison of crush results

| Assembly Type | SMF at 220 N | SMF at 440 N | MMF at 440 N |
|---|---|---|---|
| Conventional | 3.60 dB | 7.68 dB | 4.07 dB |
| Assembly | | | |
| Assembly of the | 0.48 dB | 2.97 dB | 2.19 dB |
| Present Invention | | | |

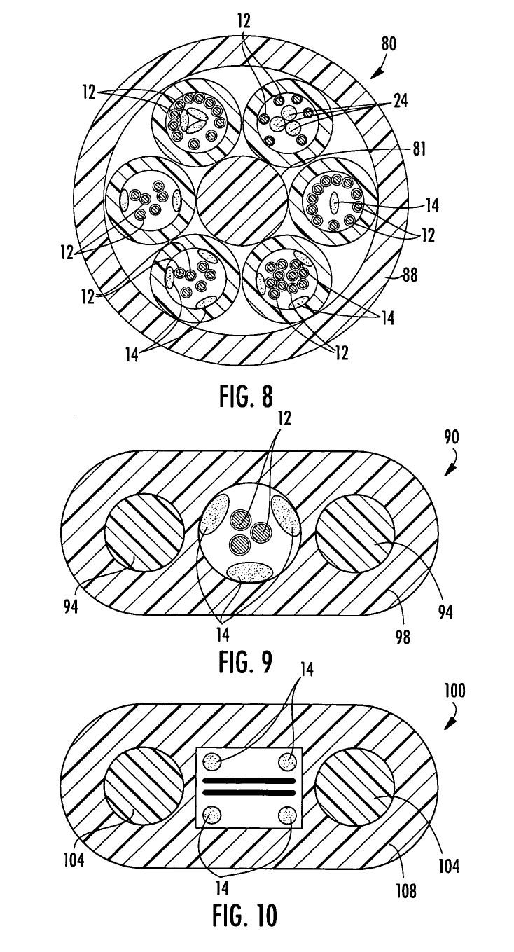

FIG. 7 is a cross-sectional view of a fiber optic cable 70 having two optical fiber assemblies 62. Fiber optic cable 70 also includes one or more strength elements 76 such as aramid yarns, fiberglass, or like, and a cable jacket 78. FIG. 8 is a cross-sectional view of another fiber optic cable 80 configured as a stranded cable design. More specifically, fiber optic cable 80 includes a plurality of optical fiber assemblies (not numbered) stranded about a central member 81 with a cable jacket 88 applied thereover. As depicted, the optical fiber assemblies of fiber optic cable 80 have different configurations such as different shapes and numbers of yarns, various locations of yarns, and different numbers of optical fibers.

Although, the previous embodiments depict the tube as being round it can have other shapes and/or include other components. For instance, FIG. 9 is a cross-sectional view of a fiber optic cable 90 according to the present invention. Fiber optic cable 90 includes optical fibers 12, water-swellable yarns 14, a plurality of strength elements 94, and a tube 98. In this embodiment, tube 98 is non-round and forms the cable jacket of fiber optic cable 90. Moreover, tube 98 includes strength elements 94 disposed therein, thereby forming a strengthened tube. Of course, variations of fiber optic cable 90 could have optical fibers 12 disposed radially outward of water-swellable yarns 14 and/or have optical fibers 12 disposed as a portion of a ribbon. Generally speaking, since fiber optic cable 90 has a low optical fiber count the placement of the optical fibers near the middle of the tube cavity allows adequate performance. Furthermore, the internal cavity (not numbered) of tube 98 could have other shapes such as generally rectangular to generally conform to the shape of one or more ribbons. FIG. 10 depicts a cross-sectional view of a fiber optic cable 100. Fiber optic cable 100 includes a plurality of optical fibers 12 (not visible) disposed in a ribbon 103 as represented by the straight lines. In this embodiment, a tube 108 has strength elements 104 disposed on opposite sides of a generally rectangular cavity (not numbered). Besides housing ribbons 103, the cavity includes a plurality of water-swellable yarns 14. Likewise, fiber optic assemblies and/or fiber optic cables according to the present invention can include other suitable cable components such as ripcords, armor, water-swellable tapes, filling or flooding compounds, or the like.

Many modifications and other embodiments of the present invention, within the scope of the claims will be apparent to those skilled in the art. For instance, the concepts of the present invention can be used with any suitable cable design. Moreover, water-swellable yarns having the textured characteristic may be used in fiber optic cables where they are unable to contact the optical fibers. It is intended that this invention covers these modifications and embodiments as well those also apparent to those skilled in the art.

1. A fiber optic assembly:
a tube,
at least one optical fiber; and
at least one water-swellable yarn, the at least one water-swellable yarn having a plurality of filaments with a textured characteristic, wherein the at least one water-swellable yarn has a nominal unstretched diameter and a nominal stretched diameter when a suitable tension is applied that essentially removes the textured characteristic from the plurality of filaments, a stretch ratio being defined as the nominal unstretched diameter divided by the nominal stretched diameter and the stretch ratio having a value of about 2 or more.

2. The fiber optic assembly of claim 1, the at least one water-swellable yarn having a textured elongation factor of about 2% or more.

3. The fiber optic assembly of claim 1, the at least one water-swellable yarn having between 100 and 1000 filaments per thousand denier.

4. The fiber optic assembly of claim 1, the at least one optical fiber being disposed radially outward of the at least one water-swellable yarn.

5. The fiber optic assembly of claim 1, the at least one optical fiber having an outer layer containing a lubricant.

6. The fiber optic assembly of claim 1, the tube being formed from a polymer having one or more fillers.

7. The fiber optic assembly of claim 1, the fiber optic assembly being a portion of a fiber optic cable.

8. The fiber optic assembly of claim 1, the fiber optic assembly being a portion of a fiber optic cable, the fiber optic cable being flame retardant.

9. The fiber optic assembly of claim 1, the at least one water-swellable yarn further including at least one filament that acts as a strength member.

10. The fiber optic assembly of claim 1, the at least one optical fiber being a non-buffered optical fiber.

11. The fiber optic assembly of claim 1, the plurality of filaments with a textured characteristic further having a filament diameter of about 50 microns or less.

12. The fiber optic assembly of claim 1, the at least one water-swellable yarn having a plurality of water-absorbent particles, the water-absorbent particles having a maximum particle size of about 100 microns or less.

13. The fiber optic assembly of claim 1, the water-swellable yarn having a coating thereon where the coating has a water-swellable characteristic.

14. A fiber optic assembly:
a tube;
at least one optical fiber; and
at least one water-swellable yarn, the at least one water-swellable yarn having a plurality of filaments with a textured characteristic, wherein the at least one water-swellable yarn has a textured elongation factor of about 2% or more.

15. The fiber optic assembly of claim 14, the at least one water-swellable yarn having a nominal unstretched diameter and a nominal stretched diameter, wherein a stretch ratio is defined as the nominal unstretched diameter divided by the nominal stretched diameter and the stretch ratio has a value of about 2 or more.

16. The fiber optic assembly of claim 14, the water-swellable yarn having between 100 and 1000 filaments per thousand denier.

17. The fiber optic assembly of claim 14, the at least one optical fiber being disposed radially outward of the at least one water-swellable yarn.

18. The fiber optic assembly of claim 14, the at least one optical fiber having an outer layer containing a lubricant.

19. The fiber optic assembly of claim 14, the tube being formed from a polymer having one or more fillers.

20. The fiber optic assembly of claim 14, the fiber optic assembly being a portion of a fiber optic cable.

21. The fiber optic assembly of claim 14, the fiber optic assembly being a portion of a flame retardant fiber optic cable.

22. The fiber optic assembly of claim 14, the at least one water-swellable yarn further including at least one filament that acts as a strength member.

23. The fiber optic assembly of claim 14, the at least one optical fiber being a non-buffered fiber.

24. The fiber optic assembly of claim 14, the plurality of filaments with a textured characteristic further having a filament diameter of about 50 microns or less.

25. The fiber optic assembly of claim 14, the at least one water-swellable yarn having a plurality of water-absorbent particles, the water-absorbent particles having a maximum particle size of about 100 microns or less,

26. The fiber optic assembly of claim 14, the water-swellable yarn having a coating thereon where the coating has a water-swellable characteristic.

27. A fiber optic assembly, comprising:
at least one water-swellable yarn, wherein the at least one water-swellable yarn has a plurality of filaments with a textured characteristic;
a plurality of optical fibers; and
a tube, wherein the plurality of optical fibers and the at least one water-swellable yarn are disposed within the tube and the plurality of optical fibers are disposed radially outward of the at least one water-swellable yarn for allowing the plurality of optical fibers to move radially outward toward the interior surface of the tube, thereby preserving optical performance.

28. The fiber optic assembly of claim 27, the at least one water-swellable yarn having a nominal unstretched diameter and a nominal stretched diameter, wherein a stretch ratio is defined as the nominal unstretched diameter divided by the nominal stretched diameter and the stretch ratio has a value of about 2 or more.

29. The fiber optic assembly of claim 27, the at least one water-swellable yarn having a textured elongation factor of about 2% or more.

30. (canceled)

31. The fiber optic assembly of claim 27, at least one of the at least one water-swellable yarns having between 100 and 400 filaments per 1000 denier.

32. The fiber optic assembly of claim 27, the at least one water-swellable yarn being one of a plurality of water-swellable yarns, wherein the plurality of water-swellable yarns are stranded together.

33. The fiber optic assembly of claim 27, the plurality of optical fibers being stranded about the at least one water-swellable yarns.

34. The fiber optic assembly of claim 27, at least one of the plurality of optical fibers having an outer layer that includes a lubricant.

35. The fiber optic assembly of claim 27, the tube being formed from a polymer containing one or more fillers.

36. The fiber optic assembly of claim 27, the fiber optic assembly being a portion of a fiber optic cable.

37. The fiber optic assembly of claim 27, the fiber optic assembly being a portion of a fiber optic cable, the fiber optic cable being flame retardant.

38. The fiber optic assembly of claim 27, the at least one water-swellable yarn further including at least one filament that acts as a strength member.

39. The fiber optic assembly of claim 27, the at least one optical fiber being a non-buffered fiber.

40. The fiber optic assembly of claim 27, the at least one water-swellable yarn having a denier between 100 and 1000.

41. The fiber optic assembly of claim 27, the at least one water-swellable yarn having a plurality of water-absorbent particles, the water-absorbent particles having a maximum particle size of about 100 microns or less.

42. The fiber optic assembly of claim 27, the water-swellable yarn having a coating thereon where the coating has a water-swellable characteristic.

43. The fiber optic assembly of claim 27, the water-swellable yarn having a plurality of filaments with a textured characteristic, the plurality of filaments having a filament diameter of about 50 microns or less.
